(19) United States
(12) Patent Application Publication
(10) Pub. No.: US 2008/0230753 A1
(43) Pub. Date: Sep. 25, 2008

(54) COLOR FILTER INK, COLOR FILTER, IMAGE DISPLAY, AND ELECTRONIC APPARATUS

(75) Inventors: Hiroshi Takiguchi, Suwa (JP); Hiroshi Kiguchi, Suwa (JP); Masaya Shibatani, Matsumoto (JP); Mitsuhiro Isobe, Kofu (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/050,423

(22) Filed: Mar. 18, 2008

(30) Foreign Application Priority Data
Mar. 19, 2007 (JP) 2007-071651

(51) Int. Cl. G02B 5/23; B41J 2/135

(52) U.S. Cl. 252/586; 347/44

(57) ABSTRACT

A color filter ink used to manufacture a color filter by an inkjet method includes a colorant and a liquid medium for dissolving and/or dispersing the colorant. If a hardened material of a urethane adhesive is left intact and sealed in the liquid medium at atmospheric pressure and at a temperature of 40° C. for ten days, a swelling rate of the hardened material is 140% or less. The liquid medium has an alkoxyl group, a carbon number of the alkoxyl group being four or more, and/or an acetyl group at an end of a molecule chain.

### CROSS REFERENCE TO RELATED APPLICATIONS

This application claims priority to Japanese Patent Application No. 2007-071651 filed Mar. 19, 2007, which is hereby expressly incorporated by reference herein in its entirety.

### BACKGROUND

1. Technical Field

The present invention relates to a color filter ink, a color filter, an image display, and an electronic apparatus.

2. Related Art

Generally, color filters are used in liquid crystal displays (LCDs) and the like for performing color display.

Color filters have been manufactured using “photolithography.” In photolithography, a coating made of a material (a composition for forming a colored layer) including a colorant, a photosensitive resin, a functional monomer, an initiator, and the like is formed on a substrate, and then an exposure process, in which light is applied to the coating using a photomask, a development process, and the like are performed. In this method, a process of forming coatings corresponding to colors on approximately the entire surface of a substrate, hardening only a part of each coating, and then eliminating most other parts is repeated. Thus, a color filter having nonoverlapping colors is manufactured. As a result, only the parts of the coatings formed to manufacture a color filter remain as colored layers of the finally obtained color filter. Most parts are removed in the manufacturing process. Therefore, this method increases the manufacturing cost of the color filter, and is not preferred in terms of resource savings.

On the other hand, methods for forming colored layers of a color filter using ink jet heads (droplet discharge heads) have been proposed in recent years (for example, see JP-A-2002-372613). These methods make it easy to control items such as the discharge positions of droplets of a material for forming colored layers (a composition for forming colored layers), as well as allow reduced waste of the composition for forming colored layers. This reduces the load on the environment, as well as reduces the manufacturing cost. However, the method for manufacturing a color filter using ink jet heads may cause problems such as variations in the droplet discharge amounts if droplets are discharged over an extended period of time. Such problems cause unevenness in color density among multiple colored parts that should have identical color densities. As a result, color unevenness or density unevenness occurs among parts of each color filter, or unevenness in characteristics (in particular, color characteristics such as a contrast ratio and a color reproduction area) occurs among many color filters. These reduce the reliability of the color filters. Incidentally, a droplet discharge apparatus for industrial use used to manufacture a color filter is quite different from that applied to a printer for consumer use and, for example, is required to discharge a great amount of droplets over an extended period of time for mass production. Also, the ink used in such an industrial droplet discharge apparatus generally has a higher viscosity and a higher specific gravity than the ink used in a consumer droplet discharge apparatus. Therefore, the load on the droplet discharge heads of the industrial droplet discharge apparatus is much higher than the load on the heads of the consumer droplet discharge apparatus. Therefore, if color filters are manufactured using a related art ink by an inkjet method, the ink jet heads of the droplet discharge apparatus rapidly deteriorate, since the apparatus is used in such harsh conditions. As a result, the inkjet heads must be replaced or repaired at a relatively high frequency. If the ink jet heads are replaced or repaired, other conditions (e.g., voltage waveform, etc.) under which droplets are discharged must be readjusted to suppress unevenness in the characteristics among many color filters. This reduces the productivity of color filters.

### SUMMARY

An advantage of the invention is to provide: an ink for inkjet color filter production allowing stable manufacture of color filters in which color unevenness and density unevenness among parts thereof are suppressed and that have excellent characteristic uniformity among individual color filters; such color filters; and an image display and an electronic apparatus each including such color filters.

According to a first aspect of the invention, a color filter ink used to manufacture a color filter by inkjet includes a colorant and a liquid medium for dissolving and/or dispersing the colorant. If a hardened material of a urethane adhesive is left intact and sealed in the liquid medium at atmospheric pressure and at a temperature of 40° C. for ten days, a swelling rate of the hardened material is 140% or less. The liquid medium has an alkoxyl group, a carbon number of the alkoxyl group being four or more, and/or an acetyl group at an end of a molecule chain.

As a result, an ink for inkjet color filter production is provided allowing stable manufacture of color filters in which color and density unevenness are suppressed and that have excellent characteristic uniformity among individual color filters.

In the color filter ink according to the first aspect of the invention, the liquid medium preferably has an acetyl group at both ends of a molecule chain.

This effectively prevents deterioration, clogging, and the like of droplet discharge heads (inkjet heads) for discharging the color filter ink, thereby allowing manufacture of high quality color filters with excellent characteristic uniformity among individual color filters.

In the color filter ink according to the first aspect of the invention, the liquid medium preferably has an alkoxyl group, a carbon number of the alkoxyl group being four or more, at both ends of a molecule chain.

This effectively prevents deterioration, clogging, and the like of droplet discharge heads (inkjet heads) for discharging the color filter ink, thereby allowing manufacture of high quality color filters with excellent characteristic uniformity among individual color filters.

In the color filter ink according to the first aspect of the invention, the liquid medium preferably has an ether oxygen atom linked to a second carbon atom, in a molecule.

This effectively prevents deterioration, clogging, and the like of droplet discharge heads (inkjet heads) for discharging the color filter ink, thereby allowing manufacture of high quality color filters with excellent characteristic uniformity among individual color filters.

In the color filter ink according to the first aspect of the invention, the color filter ink is preferably used to manufacture a color filter, by being discharged from a droplet discharge head to which a diaphragm is bonded using the urethane adhesive.

This effectively prevents deterioration, clogging, and the like of droplet discharge heads (inkjet heads) for discharging the color filter ink, thereby allowing manufacture of high quality color filters with excellent characteristic uniformity among individual color filters.

In the color filter ink according to the first aspect of the invention, a boiling point of the liquid medium at atmospheric pressure is preferably 180 to 300° C.

This effectively prevents clogging and the like of droplet discharge heads for discharging the color filter ink. As a result, the productivity of color filters is improved.

In the color filter ink according to the first aspect of the invention, a vapor pressure of the liquid medium at a temperature of 25° C. is preferably 0.1 mmHg or less.

This effectively prevents clogging and the like of droplet discharge heads for discharging the color filter ink. As a result, the productivity of color filters is improved.

According to a second aspect to the invention, a color filter is manufactured using the color filter ink according to the first aspect.

As a result, color filters are provided in which color unevenness, density unevenness, and the like among parts thereof are suppressed and that have excellent characteristic uniformity among individual color filters.

According to a third aspect to the invention, an image display includes the color filter according to the second aspect.

As a result, an image display is provided in which color unevenness, density unevenness, and the like among the respective parts of color filters of its display unit are suppressed and that has excellent characteristic uniformity among the color filters.

In the image display according to the third aspect of the invention, the image display is preferably a liquid crystal panel.

As a result, an image display is provided in which color unevenness, density unevenness, and the like among the respective parts of color filters of its display unit are suppressed and that has excellent characteristic uniformity among the color filters.

According to a fourth aspect to the invention, an electronic apparatus includes the image display according to the third aspect.

As a result, an electronic apparatus is provided in which color unevenness, density unevenness, and the like among the respective parts of color filters of its display unit are suppressed and that has excellent characteristic uniformity among the color filters.

### BRIEF DESCRIPTION OF THE DRAWINGS

The invention will be described with reference to the accompanying drawings, wherein like numbers reference like elements.

FIG. 1 is a sectional view showing a color filter according to an embodiment of the invention.

FIG. 2 is sectional views showing a color filter manufacturing method.

FIG. 3 is a perspective view showing a droplet discharge apparatus used to produce color filters.

FIG. 4 is a drawing in a case where a droplet discharger of the droplet discharge apparatus shown in FIG. 3 is observed from the stage side.

FIG. 5 is a drawing showing the bottom of a droplet discharge head of the droplet discharge apparatus shown in FIG. 3.

FIG. 6A is a perspective sectional view showing the droplet discharge head of the droplet discharge apparatus shown in FIG. 3.

FIG. 6B is a sectional view showing the droplet discharge head of the droplet discharge apparatus shown in FIG. 3.

FIG. 7 is a sectional view showing a liquid crystal display according to this embodiment.

FIG. 8 is a perspective view showing a configuration of a mobile (or notebook) personal computer to which an electronic apparatus according to this embodiment is applied.

FIG. 9 is a perspective view showing a configuration of a cellular phone (such cellular phones include personal handyphone system (PHS) phones) to which an electronic apparatus according to this embodiment is applied.

FIG. 10 is a perspective view showing a configuration of a digital still camera to which an electronic apparatus according to this embodiment is applied.

### DESCRIPTION OF EXEMPLARY EMBODIMENTS

A preferred embodiment of the invention will now be described in detail.

Color Filter Ink

A color filter ink according to this embodiment is used to produce color filters (that is, an ink used to form colored parts of color filters) and, in particular, is used to produce color filters by an inkjet method.

The color filter ink includes a colorant, a liquid medium for dissolving and/or dispersing the colorant, a resin material, and the like.

Colorant

In general, a color filter includes colored parts having different colors (typically, colored parts corresponding to three colors, RGB). A colorant is generally selected according to the tones of colored parts to be formed. For example, various types of pigments and various types of dyes are used as a colorant included in a color filter ink.

Among such pigments are C.I. pigment red 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, and 108:1, C.I. pigment green 7, 36, 15, 17, 18, 19, 26, and 50, C.I. pigment blue 1, 15, 15:1, 15:2, 15:3, 15:4, 15:6, 17:1, 18, 60, 27, 28, 29, 35, 36, and 80, C.I. pigment yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, and 157, C.I. pigment violet 1, 3, 19, 23, 50, 14, and 16, C.I. pigment orange 5, 13, 16, 36, 43, 20, 20:1, and 104, and C.I. pigment brown 25, 7, and 33.

Among such dyes are azo dyes, anthraquinone dyes, polycyclic aromatic carbonyl dyes, indigoid dyes, carbonium dyes, phthalocyanine dyes, methine dyes, and polymethine dyes. Specifically, these dyes include C.I. direct red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247, C.I. acid red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397, C.I. reactive red 3, 13, 17, 19, 21, 22, 23, 24, 29, 35, 37, 40, 41, 43, 45, 49, and 55, C.I. basic red 12, 13, 14, 15, 18, 22, 23, 24, 25, 27, 29, 35, 36, 38, 39, 45, and 46, C.I. direct violet 7, 9, 47, 48, 51, 66, 90, 93, 94, 95, 98, 100, and 101, C.I. acid violet 5, 9, 11, 34, 43, 47, 48, 51, 75, 90, 103, and 126, C.I. reactive violet 1, 3, 4, 5, 6, 7, 8, 9, 16, 17, 22, 23, 24, 26, 27, 33, and 34, C.I. basic violet 1, 2, 3, 7, 10, 15, 16, 20, 21, 25, 27, 28, 35, 37, 39, 40, and 48, C.I. direct yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163, C.I. acid yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227, C.I. reactive yellow 2, 3, 13, 14, 15, 17, 18, 23, 24, 25, 26, 27, 29, 35, 37, 41, and 42, C.I. basic yellow 1, 2, 4, 11, 13, 14, 15, 19, 21, 23, 24, 25, 28, 29, 32, 36, 39, and 40, C.I. acid green 16, C.I. acid blue 9, 45, 80, 83, 90, and 185, and C.I. basic orange 21 and 23.

Also, what is obtained by subjecting powders made of a material as described above to a surface treatment such as a lyophilic nature improvement treatment (a treatment for improving a lyophilic nature to a liquid medium to be discussed later) may be used as a colorant. By doing so, for example, the dispersibility and dispersion stability of colorant particles in the color filter ink is improved. Among such surface treatments to a colorant is a treatment in which the surfaces of colorant particles are reformed by polymers. Such polymers for reforming the surfaces of colorant particles include a polymer described in JP-A-08-259876 and the like, various types of polymers for dispersing a pigment, which are commercially available, and an oligomer.

Also, a combination of two or more types of ingredients selected from the above-mentioned materials may be used as a colorant.

In the color filter ink, the colorant may be one dissolved in a liquid medium (to be discussed later) or may be one dispersed therein. If the colorant is one dispersed in a liquid medium, the average particle diameter of the colorant is preferably 20 to 200 nm, and more preferably 30 to 180 nm. By doing so, the light stability of color filters manufactured using the color filer ink is sufficiently improved. Also, the dispersion stability of the colorant in the color filter ink and the chromomeric effect of the color filters are significantly improved.

The colorant content of the color filter ink is preferably 2 to 20 wt %, and more preferably 3 to 15 wt %. If the colorant content falls within the above-mentioned range, the dischargeability of the color filter ink from the droplet discharge heads (inkjet heads) is significantly improved and color filters having excellent durability are manufactured. Also, a sufficient color density is secured in manufactured color filters.

Liquid Medium

The liquid medium has a function of dissolving and/or dispersing a colorant as described above. In other words, the liquid medium serves as a solvent and/or a dispersion medium. Generally, most of the liquid medium is eliminated in the process of manufacturing color filters.

The color filter ink according to this embodiment includes a liquid medium that has an alkoxyl group and/or an acetyl group at an end of a molecular chain and that meets the following condition. That is, when a hardened material of a urethane adhesive is left intact in the liquid medium, which is sealed, at atmospheric pressure and at a temperature of 40 for ten days, the swelling rate of the hardened material (hereafter referred to as “the swelling rate of the urethane adhesive) is 140% or less. By meeting such a condition, the conditions such as the amount of discharge of droplets are stably met even if droplets are discharged over an extended period of time to manufacture color filters using the inkjet method. This allows manufacture of color filters with stable quality over an extended period of time. Specifically, color filters in which color unevenness and density unevenness among parts thereof are suppressed and that have excellent characteristic uniformity among individual color filters are manufactured stably over an extended period of time. Further, meeting a condition as described above effectively prevents the deterioration of the droplet discharge heads for discharging droplets. Therefore, even if many color filters are manufactured, the frequency of maintenance of the droplet discharge heads, such as the replacement or repair thereof, is reduced. As a result, the productivity of color filters is improved.

On the other hand, if the swelling rate of the urethane adhesive with respect to the liquid medium is too high, the discharge conditions are met unstably if droplets are discharged over an extended period of time to manufacture color filters using the inkjet method. This makes it difficult to sufficiently suppress color unevenness, density unevenness, and the like between parts of each of manufactured color filters. Also, if many color filters are manufactured, characteristic unevenness among individual color filters is increased. This makes it difficult to stably produce color filters with excellent quality. The swelling rate of the hardened material of the urethane adhesive may be measured, for example, using a discoid test piece with a diameter of 6 mm and a thickness of 4 mm.

As described above, according to this embodiment, if a hardened material of a urethane adhesive is left intact in the liquid medium, which is sealed, at atmospheric pressure and at a temperature of 40 for ten days, the swelling rate of the hardened material is 140% or less. Such a swelling rate is preferably 90% or less, and more preferably 70% or less. These make the above-described advantages of the invention more remarkable.

Unless a liquid medium having a chemical structure as described above is used, it is difficult to sufficiently prevent the color filter ink from negatively affecting the droplet discharge heads or to make the viscosity or vapor pressure (nonvolatility) of the color filter ink a preferable value. Thus, if droplets are discharged over an extended period of time to manufacture color filters using the inkjet method, the droplet discharge conditions are met unstably. This makes it difficult to sufficiently suppress color unevenness, density unevenness, and the like among parts of each manufactured color filter. Also, if many color filters are manufactured, unevenness in characteristics among individual color filters is increased. This makes it difficult to stably produce color filters with excellent quality.

Among compounds that have a structure as described above and may be used as a liquid medium are 2-(2-methoxy-1-methylethoxy)-1-methyl ethyl acetate, diethylene glycol monoethyl ether acetate, bis(2-butoxyethyl)ethyl, ethylene glycol di-n-butyrate, 1,3-butylene glycol diacetate, diethyleneglycol monobutyl ether acetate, 1,6-diacetoxyhexane, butoxyethanol, 3-methoxy butyl acetate, ethylene glycol monobutyl ether acetate, cyclohexyl acetate, ethylene glycol diacetate, propylene glycol diacetate, 1-butoxy-2-propanol, 3-methoxy-n-butyl acetate, ethylene glycol monohexyl ether, dipropylene glycoln-butyl ether, diethyleneglycol butyl methyl ether, triethylene glycol butyl methyl ether, tripropylene glycoln-butyl ether, dipropylene glycoln-butyl methyl ether, 1-butoxy-2-propanol, and 2-butoxy-1-propanol, and a combination of two or more selected from these materials.

While it is sufficient that the color filter ink according to this embodiment includes a liquid medium having an alkoxyl group, whose carbon number is 4 or more, and/or an acetyl group at an end of a molecular chain, the color filter ink may include a liquid medium having an acetyl group at both ends of the molecular chain. This effectively prevents deterioration, clogging, and the like of the droplet discharge heads (inkjet heads) for discharging the color filter ink. As a result, high quality color filters with excellent characteristic uniformity among individual color filters are manufactured. Among compounds (liquid media) having an acetyl group at both ends of the molecular chain are 1,3-butylene glycol diacetate, 1,6-diacetoxyhexane, ethylene glycol diacetate, and propylene glycol diacetate.

Also, the color filter ink may include a liquid medium having an alkoxyl group, whose carbon number is 4 or more, at both ends of a molecular chain. This effectively prevents deterioration, clogging, and the like of the droplet discharge heads (inkjet heads) for discharging the color filter ink. As a result, high quality color filters with excellent characteristic uniformity among individual color filters are manufactured. Among compounds (liquid media) having an alkoxyl group, whose carbon number is 4 or more, at both ends of a molecular chain are bis(2-butoxyethyl)ethyl and triethylene glycol dibutyl ether.

Also, the color filter ink may include a liquid medium having an ether oxygen atom linked to a second carbon atom (a carbon atom linked to two carbon atoms) in a molecule. This effectively prevents deterioration, clogging, and the like of droplet discharge heads (inkjet heads) for discharging the color filter ink. As a result, high quality color filters with excellent characteristic uniformity among individual color filters are manufactured. Among compounds (liquid media) having an ether oxygen atom linked to a second carbon atom in a molecule are 2-(2-methoxy-1-methylethoxy)-1-methyl ethyl acetate, 3-methoxy butyl acetate, dipropylene glycoln-butyl ether, tripropylene glycoln-butyl ether, dipropylene glycoln-butyl methyl ether, 1-butoxy-2-propanol, and 2-butoxy-1-propanol.

The boiling point of the liquid medium at atmospheric pressure (1 atmospheric pressure) is preferably 180 to 300° C., more preferably 190 to 290° C., and still more preferably 230 to 280° C. If such a boiling point falls within any of the above-mentioned ranges, deterioration, clogging, and the like of droplet discharge heads (inkjet heads) for discharging the color filter ink is effectively prevented. As a result, the productivity of color filters is significantly improved.

The vapor pressure of the liquid medium at a temperature of 25° C. is preferably 0.1 mmHg or less, and more preferably 0.05 mmHg or less. If the vapor pressure of the liquid medium falls within any of the above-mentioned ranges, deterioration, clogging, and the like of the droplet discharge heads (inkjet heads) for discharging the color filter ink is effectively prevented. As a result, the productivity of color filters is significantly improved.

The vapor pressure of the liquid medium at a temperature of 25° C. is preferably 0.1 mmHg or less, and more preferably 0.05 mmHg or less. If the vapor pressure of the liquid medium falls within any of the above-mentioned ranges, deterioration, clogging, and the like of the droplet discharge heads (inkjet heads) for discharging the color filter ink is effectively prevented. As a result, the productivity of color filters is significantly improved.

The liquid medium content of the color filter ink is preferably 70 to 98 wt %, and more preferably 80 to 95 wt %. If the liquid medium content falls within any of the above-mentioned ranges, the dischargeability of the color filter ink from the droplet discharge heads (inkjet heads) is significantly improved, and color filters having excellent durability are manufactured. Also, a sufficient color density is secured in manufactured color filters.

Dispersant

The color filter ink may include a dispersant. By doing this, for example, even if the color filter ink includes a pigment having low dispersibility, the dispersion stability of the pigment is improved. As a result, the preservation stability of the color filter ink is improved.

Among such dispersants are cationic, anionic, nonionic, ampholytic, silicone, and fluorochemical surfactants. Specifically, such surfactants include polyoxyethylene alkyl ethers, such as polyoxyethylene lauryl ether, polyoxyethylene stearyl ether, and polyoxyethylene oleyl ether; polyoxyethylene alkyl phenyl ethers, such as polyoxyethylene n-octyl phenyl ether and polyoxyethylene n-nonyl phenyl ether; polyethylene glycol diesters, such as polyethylene glycol dilaurate and polyethylene glycol distearate; sorbitan fatty acid esters; fatty acid-modified polyesters; tertiary amine-modified polyurethanes; and polyethyleneimines, and the following products: KP (manufactured by Shin-Etsu Chemical Co., Ltd.), Poly-Flow (manufactured by Kyoeisha Chemical Co., Ltd.), FTOP (manufactured by Tohkem Products Corporation), MEGAFAC (manufactured by Dainippon Ink and Chemicals, Inc.), Florard (manufactured by Sumitomo 3M Ltd.), Asahi Guard and Surflon (manufactured by Asahi Glass Co., Ltd.), Disperbyk (manufactured by BYK Japan KK), Solsperse 3000, 5000, 11200, 12000, 13240, 13650, 13940, 16000, 17000, 18000, 20000, 21000, 22000, 24000SC, and 24000GR (manufactured by Lubrizol Japan Limited).

The dispersant may be, for example, a compound having a cyamelide. Use of such a compound as a dispersant significantly improves the dispersibility of the pigment in color filter ink as well as the discharge stability of the color filter ink.

Also, the dispersant may be, for example, a compound having a substructure represented by Formula I or Formula II shown below. Use of such a compound as a dispersant significantly improves the dispersibility of the colorant (pigment) in the color filter ink as well as the discharge stability of the color filter ink.

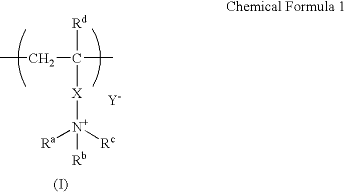

where R^{a}, R^{b}, and R^{c} independently denote a hydrogen atom or an annular or chain hydrocarbon group that may be replaced or two or more of R^{a}, R^{b}, and R^{c} are linked to each other so as to form an annular structure, R^{d} denotes a hydrogen atom or a methyl group, X denotes a divalent linking group, and Y⁻ denotes a pairing anion.

Chemical Formula 2

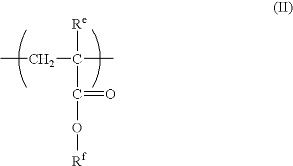

where R^{e} denotes a hydrogen atom or a methyl group, and R^{f} denotes an annular or chain alkyl group that may have a substituent, an aryl group that may have a substituent, or an aralkyl group that may have a substituent.

The dispersant content of the color filter ink is preferably 0.5 to 15 wt %, and more preferably 0.5 to 8 wt %.

Resin Material

A color filter ink generally includes a resin material (binder resin). By doing so, color filters in which the colored layers thereof exhibit excellent adhesiveness to the substrate are manufactured. As a result, the durability of the color filters is improved.

While the resin material included in the color filter ink may be any resin material, such as various types of thermoplastic resins and various types of thermosetting resins, it is preferably an epoxy resin. An epoxy resin has high transparency and high hardness, as well as is small in amount of thermal contraction. Therefore, use of an epoxy resin significantly improves the adhesiveness of the colored layers to the substrate. Among epoxy resins, an epoxy resin having a silyl acetate structure (SiOCOCH₃) and an epoxy structure is preferably used. By doing this, preferred discharge of droplets using the inkjet method is performed. Also, the adhesiveness of the colored layers to the substrate is significantly improved. As a result, the durability of the color filters is significantly improved.

The resin material content of the color filter ink is preferably 0.5 to 10 wt %, and more preferably 1 to 5 wt %. If the resin material content falls within any of the above-mentioned ranges, the dischargeability of the color filter ink from the droplet discharge heads is significantly improved, and color filters having excellent durability are manufactured. Also, a sufficient color density is secured in the manufactured color filters. On the other hand, if the resin material content is too low, the dischargeability of the color filter ink from the droplet discharge heads is reduced, or colored parts having lower hardness are formed. As a result, the durability of manufactured color filters is reduced. If the resin material content is too high, it is difficult to secure a sufficient color density in manufactured color filters.

Other Ingredients

The color filter ink may include various other ingredients as necessary. Among such ingredients (other additives) are various types of crosslinking agents; various types of initiators; dispersion aids such as blue pigment derivatives and yellow pigment derivatives, including copper phthalocyanine derivatives; fillers such as glass and alumina; polymer compounds such as polyvinyl alcohol, polyethylene glycolmonoalkyl ether, and poly(fluoroalkylacrylate); adhesion accelerators such as vinyltrimethoxysilane, vinyltriethoxysilane, vinyltris(2-methoxyethoxy)silane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidoxypropylmethyl dimethoxysilane, 2,2-(3,4-epoxycyclohexyl)ethyl trimethoxysilane, 3-chloropropylmethyl dimethoxysilane, 3-chloropropyl trimethoxysilane, 3-methacryloxypropyl trimethoxysilane, and 3-mercaptopropyl trimethoxysilane; antioxidants such as 2,2-thiobis(4-methyl-6-t-butylphenol) and 2,6-di-t-butylphenol; ultraviolet absorbers such as 2-(3-t-butyl-5-methyl-2-hydroxyphenyl)-5-chlorobenzotriazole and alkoxybenzophenone; aggregation inhibitors such as sodium polyacrylate; and inkjet discharge performance stabilizers such as methanol, ethanol, i-propanol, n-buthanol, and glycerin; and surfactants such as FTOP EF301, EF303, and EF352 (manufactured by Shin Akita Kasei KK), MEGAFAC F171, F172, F173, and F178K (manufactured by Dainippon Ink and Chemicals, Inc.), Florard FC430, FC431 (manufactured by Sumitomo 3M Ltd.), Asahi Guard AG710 and Surflon S-382, SC-101, SC-102, SC-103, SC-104, SC-105, and SC-106 (manufactured by Asahi Glass Co., Ltd.), KP341 (manufactured by Shin-Etsu Chemical Co., Ltd.), and Polyflow Nos. 75 and 95 (manufactured by Kyoeisha Chemical Co., Ltd.).

The color filter ink may include a thermal acid generator or an acid crosslinking agent. A thermal acid generator is an ingredient that generates an acid by undergoing heating. Among thermal acid generators are onium salts such as sulfonium salt, benzothiazilium salt, ammonium salt, and phosphonium salt. Among others, sulfonium salt and benzothiazilium salt are preferably used.

While the viscosity (viscosity measured using a vibration-type viscometer) of the color filter ink at a temperature of 25° C. is not limited to a particular one, it is preferably 5 to 15 mPa·s, and more preferably 5 to 10 mPa·s. If the viscosity of the color filter ink falls within any of the above-described ranges, unevenness in droplet amounts of the color filter ink discharged using an inkjet technique to be discussed later is significantly reduced. Also, clogging of the droplet discharge heads and such is reliably prevented. The viscosity of the color filter ink may be measured, for example, using a vibration-type viscometer, particularly, in conformity with JIS Z8809.

Ink Set

The above-described color filter ink is used to produce color filters using the inkjet method. A color filter generally includes colored parts having multiple colors (typically, three primary colors of light, RGB) so as to support full color display. In order to form colored parts having these multiple colors, multiple color filter inks corresponding to the multiple colors are used. That is, an ink set including color filter inks corresponding to multiple colors is used to produce color filters. While it is sufficient that the above-described color filter ink is used to form colored parts having at least one color when manufacturing color filters, it is preferable that such color filter inks be used to form colored parts having all colors.

Color Filter

An example of a color filter manufactured using the above-described color filter ink (ink set) will now be described.

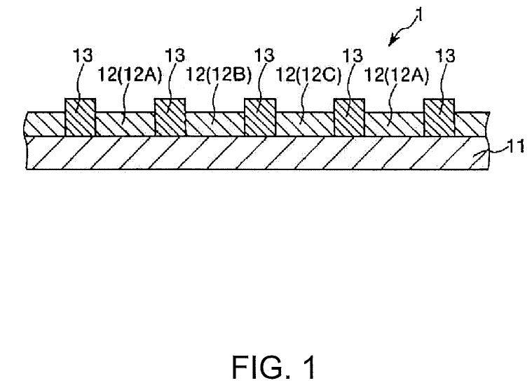

FIG. 1 is a sectional view showing a color filter according to this embodiment.

As shown in FIG. 1, a color filter 1 includes a substrate 11 and colored parts 12 formed using the above-described color filter ink. The colored parts 12 include first colored parts 12A, second colored parts 12B, and third colored parts 12C, which have different colors. A bank 13 is provided between each two adjacent colored parts 12.

Substrate

The substrate 11 is a plate-shaped component having optical transparency and has a function of holding the colored parts 12 and the banks 13.

The substrate 11 is preferably made of a substantially transparent material. By doing so, light transmitted through the color filter 1 forms clearer images.

The substrate 11 preferably has excellent thermal resistance and excellent mechanical strength. By doing so, for example, the substrate 11 is reliably prevented from suffering deformation caused by heat applied when manufacturing the color filter 1. Among materials for the substrate 11 meeting these conditions are glass, silicon, polycarbonate, polyester, aromatic polyamide, polyamide imide, polyimide, and norbornene ring-opened polymer and hydrogen added polymer thereof.

Colored Part

The colored parts 12 are formed using the above-described color filter ink. Therefore, unevenness in characteristic among pixels is small. This makes the color filter 1 a highly reliable color filter in which color unevenness, density unevenness, and the like are suppressed.

Each colored part 12 is provided in a cell 14 that is a region surrounded by the banks 13 to be discussed later.

The first colored parts 12A, the second colored parts 12B, and the third colored parts 12C have different colors. For example, the first colored parts 12A are set to red filter regions (R), the second colored parts 12B to green filter regions (G), and the third colored parts 12C to blue filter regions (B). A set of a colored part 12A, a colored part 12B, and a colored part 12C, which have different colors, constitutes one pixel. A predetermines number of colored parts 12 are disposed in the lateral and vertical directions of the color filter 1. For example, if the color filter 1 is a color filter for a high-definition television, 1366×768 pixels are disposed. If the color filter 1 is a color filter for a full high-definition television, 1920×1080 pixels are disposed. If the color filter 1 is a color filter for a super-high-definition television, 7680×4320 pixels are disposed. The color filter 1 may have spare pixels outside the effective region.

Bank

Each bank 13 is provided between each two adjacent colored parts 12. By doing so, adjacent colored parts 12 are reliably prevented from causing color mixture. As a result, clear images are reliably displayed.

While the banks may be made of a transparent material, they are preferably made of a light-shielding material. By doing so, images having excellent contrast are displayed. While the color of the banks (light-shielding parts) is not limited to a particular one, it is preferably black. By doing so, images having excellent contrast are displayed.

While the banks are not limited to a particular height, it is preferably larger than the film thickness of the colored parts 12. By doing so, the adjacent colored parts 12 are reliably prevented from causing color mixture. Specifically, the thickness of the banks 13 is preferably 0.1 to 10 μm, and more preferably 0.5 to 3.5 μm. By doing so, adjacent colored parts 12 are reliably prevented from causing color mixture. Also, the viewing angle characteristic of an image display or an electronic apparatus including the color filter 1 is improved.

While the banks 13 may be made of any material, they are preferably mainly made of a resin material. By doing so, the banks 13 are easily formed into a desired shape using a method as described later. If the banks 13 have a function as light-shielding parts, the material for the banks 13 may includes a light-absorptive material, such as carbon black.

Color Filter Manufacturing Method

An example of a method for manufacturing the color filter 1 will now be described.

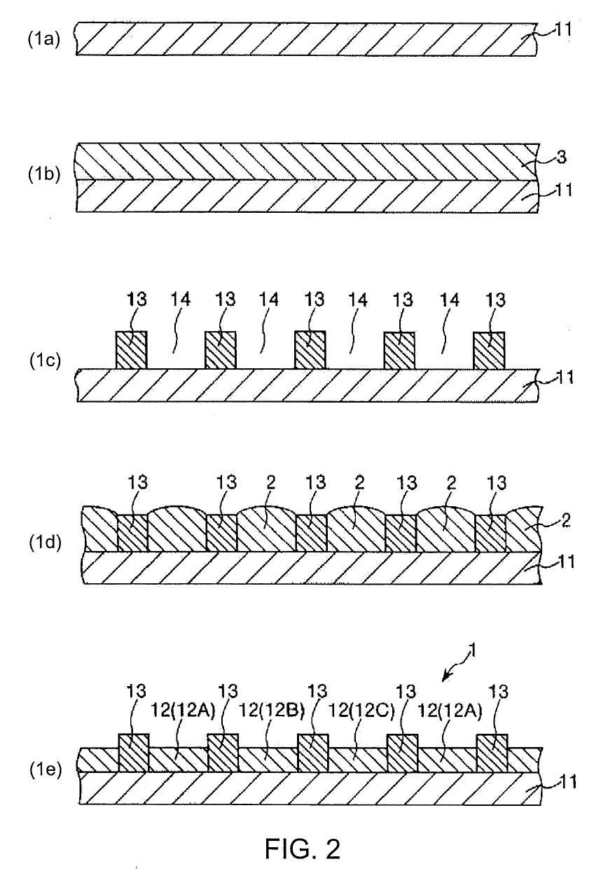

FIG. 2 is sectional views showing a color filter manufacturing method.

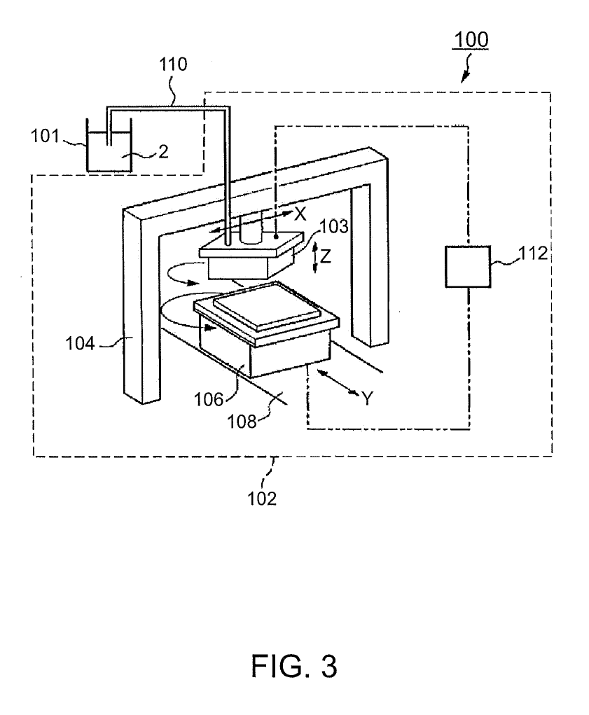

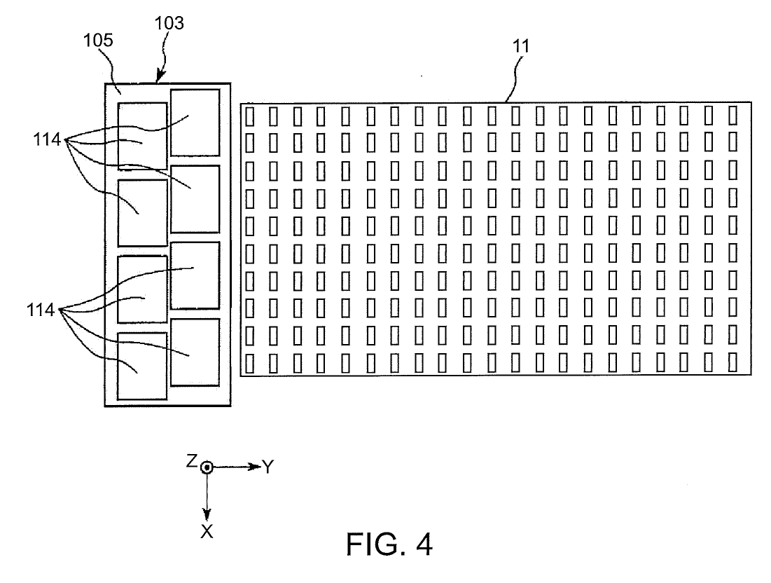

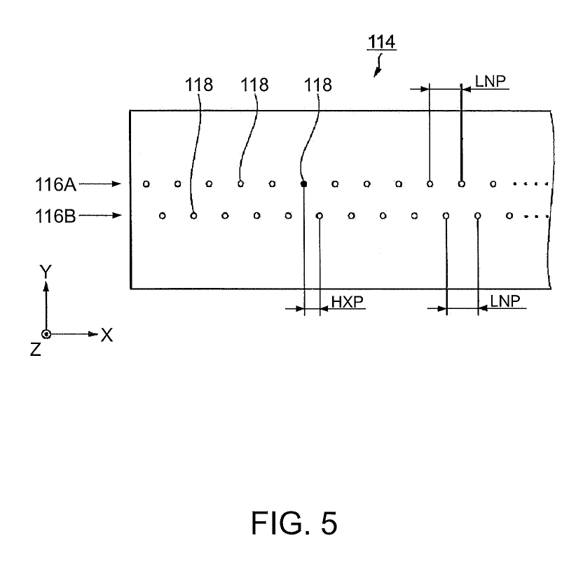

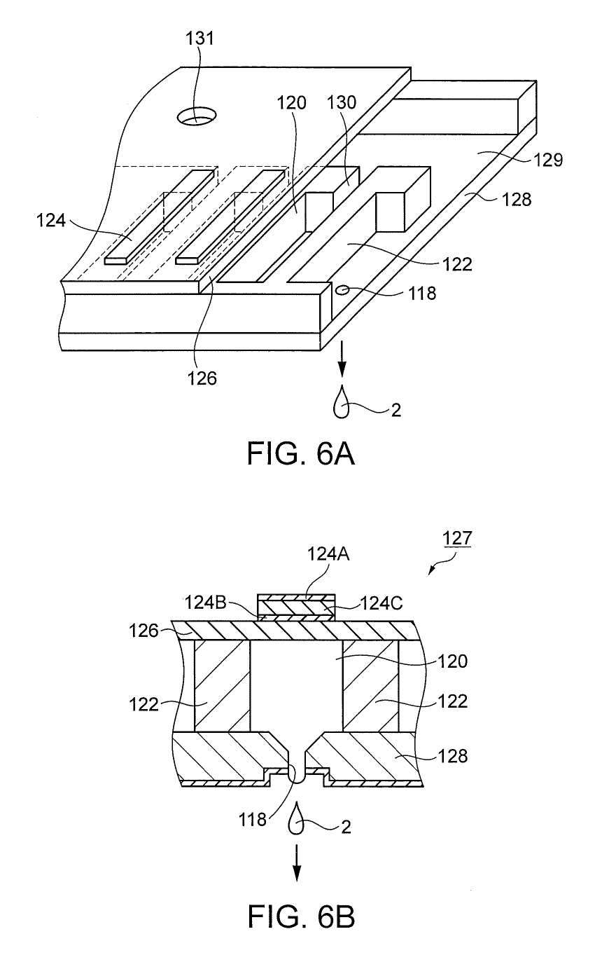

FIG. 3 is a perspective view showing a droplet discharge apparatus used to produce color filters. FIG. 4 is a drawing in a case where a droplet discharger of the droplet discharge apparatus shown in FIG. 3 is observed from the stage side. FIG. 5 is a drawing showing the bottom of a droplet discharge head of the droplet discharge apparatus shown in FIG. 3. FIGS. 6A and 6B are drawings showing the droplet discharge head of the droplet discharge apparatus shown in FIG. 3. FIG. 6A is a sectional perspective view and FIG. 6B is a sectional view.

As shown in FIG. 2, the color filter manufacturing method according to this embodiment includes a substrate preparation step (1a) of preparing the substrate 11, bank forming steps (1b, 1c) of forming the banks 13 on the substrate 11, an ink providing step (1d) of providing the color filter ink 2 to regions surrounded by the banks 13 using the inkjet method, and a colored part forming step (1e) of forming the solid colored parts 12 by eliminating a liquid medium from the provided color filter ink 2.

Substrate Preparation Step

First, the substrate 11 is prepared (1a). The substrate 11 prepared in this step is preferably a substrate previously subjected to cleaning. The substrate 11 prepared in this step may also be a substrate subjected to a necessary pretreatment such as a chemical treatment using a silane coupling agent or the like, plasma processing, ion-plating, sputtering, a gas phase reaction method, or vacuum deposition.

Bank Forming Step

Next, a radiation-sensitive composition for forming banks on the substrate 11 is applied onto almost all of one surface of the substrate 11 so as to form a coating 3 (1b). After the radiation-sensitive composition is applied onto the substrate 11, pre-baking may be performed as necessary. Such pre-baking may be performed, for example, under the conditions: heating temperature of 50 to 150° C. and heating time of 30 to 600 sec.

Subsequently, post-exposure baking (PEB) is performed by applying a radiation to the coating using a photomask and development is performed using an alkali developer. Thus, the banks 13 are formed (1c). Such PEB may be performed, for example, under the conditions: heating temperature of 50 to 150° C., heating time of 30 to 600 sec, and radiation application intensity of 1 to 500 mJ/cm². Such development may be performed, for example, using a developer application method, dipping, a vibration/development method or the like. The development time may be set to 10 to 300 sec. After the development is performed, post-baking may be performed as necessary. Such post-baking may be performed, for example, under the conditions: heating temperature of 150 to 280° C. and heating time of 3 to 120 min.

Ink Providing Step

Next, the color filter ink 2 is provided into the cells 14 surrounded by the banks 13 using the inkjet method (1d).

This step is performed using multiple color filter inks corresponding to the colored parts 12 having multiple colors to be formed. In this case, the banks 13 reliably prevent two or more types of color filter ink 2 from being mixed with each other.

The color filter ink 2 is discharged from a droplet discharge apparatus as shown in FIGS. 3 to 6.

As shown in FIG. 3, a droplet discharge apparatus 100 used in this step includes a tank 101 for containing the color filter ink 2, a tube 110, and a discharge scan unit 102 for receiving the color filter ink 2 from the tank 101 via the tube 110. The discharge scan unit 102 includes a droplet discharger 103 having a carriage 105 and multiple droplet discharge heads (inkjet heads) 114 mounted on the carriage 105, a first position controller 104 (carrier) for controlling the position of the droplet discharger 103, a stage 106 for holding the substrate 11 having thereon the banks 13 formed in the previous step, a second position controller 108 (carrier) for controlling the position of the stage 106, and a controller 112. The tank 101 and the multiple droplet discharge heads 114 of the droplet discharger 103 are coupled via the tube 110, and the color filter ink 2 is provided from the tank 101 to each of the multiple droplet discharge heads 114 using compressed air.

The first position controller 104 moves the droplet discharger 103 along the X axis direction and the Z axis direction perpendicular to the X axis direction according to a signal from the controller 112. The first position controller 104 also has a function of rotating the droplet discharger 103 about an axis parallel to the Z axis. In this embodiment, the Z axis direction is a direction parallel to the vertical direction (that is, the direction of gravitational acceleration). The second position controller 108 moves the stage 106 along the Y axis direction perpendicular to both the X axis direction and Z axis direction according to a signal from the controller 112. The second position controller 108 also has a function of rotating the stage 106 about an axis parallel to the Z axis.

The stage 106 has a plane parallel to both the X and Y axis directions. The stage 106 is configured so that the substrate 11 having thereon the cells 14 for receiving the color filter ink 2 is fixed to or held on a plane of the stage 106.

As described above, the droplet discharger 103 is moved in the X axis direction by the first position controller 104, while the stage 106 is moved in the Y axis direction by the second position controller 108. In other words, the positions of the droplet discharge heads 114 relative to the stage 106 are changed by the first and second position controllers 104 and 108 (the substrate 11 held by the stage 106 an the droplet discharger 103 are moved relatively to each other).

The controller 112 is configured to receive discharge data indicating relative positions to which the color filter ink 2 should be discharged, from an external information processing device.

As shown in FIG. 4, the droplet discharger 103 includes the multiple droplet discharge heads 114 having almost identical structures and the carriage 105 for holding the droplet discharge heads 114. In this embodiment, the droplet discharger 103 holds eight droplet discharge heads 114. Each droplet discharge head 114 has a bottom on which multiple nozzles 118 to be discussed later are provided. The bottom of each droplet discharge head 114 takes the shape of a polygon having two long edges and two short edges. The bottoms of the droplet discharge heads 114 held by the droplet discharger 103 are orientated toward the stage 106. The long edge direction and the short edge direction of each droplet discharger head 114 are parallel to the X axis direction and the Y axis direction, respectively.

As shown FIG. 5, each droplet discharge head 114 has the multiple nozzles 118 arranged in the X axis direction. The multiple nozzles 118 are arranged so that a nozzle pitch HXP in the X axis direction on each droplet discharge head 114 is a predetermined value. While the value of the nozzle pitch HXP is not limited to a particular one, it may be, for example, 50 to 90 μm. Here, the “nozzle pitch HXP in the X axis direction on each droplet discharge head 114” corresponds to the pitch between each adjacent two of multiple nozzle images obtained by projecting all the nozzles 118 on the droplet discharge head 114, on the X axis along the Y axis direction.

In this embodiment, the multiple nozzles 118 on each droplet discharge head 114 constitute a nozzle line 116A and a nozzle line 116B both extending in the X axis direction. The nozzle lines 116A and 116B are arranged in parallel at an interval. In this embodiment, ninety nozzles 118 are arranged in a row at given intervals LNP in the X axis direction in each of the nozzle lines 116A and 116B. While the value of the LNP is not limited to a particular one, it may be 100 to 180 μm.

The positions of the nozzles in the nozzle line 116B are shifted in the positive direction (right direction in FIG. 5) of the X axis direction relative to the positions of the nozzles in the nozzle line 116A by half the length of the nozzle pitch LNP. Therefore, the nozzle pitch HXP in the X axis direction of the droplet discharge head 114 is half the length of the nozzle pitch LNP of the nozzle line 116A (or nozzle line 116B).

Therefore, the nozzle line density of each droplet discharge head 114 in the X axis direction is twice the nozzle line density of the nozzle line 116A (or nozzle line 116B). In this specification, the “nozzle line density in the X axis direction” corresponds to the number per unit length of the multiple nozzle images obtained by projecting the multiple nozzles on the X axis along the Y axis direction. Of course, the number of nozzle lines included in each droplet discharge head 114 is not limited to two. Each droplet discharge head 114 may include an M number of nozzle lines. Here, the M is a natural number of one or more. In this case, the multiple nozzles 118 are arranged in each of the M number of nozzle lines at pitches having M times the length of the nozzle pitch HXP. Further, if the M is a natural number of two or more, the nozzles in each of a (M−1) number of nozzle lines are shifted in the X axis direction relative to the nozzles in the remaining one nozzle line by i times the length of the nozzle pitch HXP, without overlapping one another. Here, “″” is a natural number of one to (M−1).

Since the nozzle lines 116A and 116b each include ninety nozzles 118 in this embodiment, each droplet discharge head 114 includes one hundred eighty nozzles 118. Note that five nozzles at both ends of the nozzle line 116A are set to be “nonoperating nozzles.” Likewise, five nozzles at both ends of the nozzle line 116B are set to be “nonoperating nozzles.” Therefore, the color filter ink 2 is not discharged from these twenty “nonoperating nozzles.” In other words, among the one hundred eighty nozzles 118 on each droplet discharge head 114, the one hundred sixty nozzles 118 serve as nozzles for discharging the color filter ink 2.

As shown in FIG. 4, the multiple droplet discharge heads 114 are disposed in two lines along the X axis direction on the droplet discharger 103. The droplet discharge heads 114 in one line and those in the other line are disposed to partially overlap each other when seen from the Y axis direction, in consideration of the nonoperating nozzles. Thus, the nozzles 118 for discharging the color filter ink 2 are continuously disposed in the X axis direction at the nozzle pitch HXP on the droplet discharger 103, so as to cover the length of the substrate 11 in the X axis direction.

While the droplet discharge heads 114 are disposed on the droplet discharger 103 according to this embodiment so as to cover the length of the substrate 11 in the X axis direction, the droplet discharge heads 114 may be disposed to cover a part of such a length.

As shown in FIGS. 6A and 6B, each droplet discharge head 114 is an inkjet head. More specifically, each droplet discharge head 114 includes a diaphragm 126 and a nozzle plate 128. A liquid reservoir 129 that is always filled with the color filter ink 2 provided from the tank 101 via a hole 131 is positioned between the diaphragm 126 and the nozzle plate 128.

Multiple partitions 122 are also positioned between the diaphragm 126 and the nozzle plate 128. Space enclosed by the diaphragm 126, the nozzle plate 128, and a pair of partitions 122 is a cavity 120. Since the cavity 120 is provided to correspond to the nozzle 118, the number of the cavities 120 is the same as that of the nozzles 118. The cavity 120 receives the color filter ink 2 from the reservoir 129 via an inlet 130 positioned between a pair of partitions 122.

A vibrator 124 is positioned on each diaphragm 126 so as to correspond to each cavity 120. The vibrator 124 includes a piezoelectric element 124C and a pair of electrodes 124A and 124B between which the piezoelectric element 124C is interposed. Application of a drive voltage between the pair of electrodes 124A and 124B allows the color filter ink 2 to be discharged from the corresponding nozzle 118. The shape of the nozzle 118 is adjusted so that the color filter ink 2 is discharged from the nozzle 118 in the Z axis direction.

In general, an adhesive is used at the junctions between the components of a droplet discharge head. For example, such as the junction between a diaphragm and a partition, by which the durability of a droplet discharge head is substantially influenced, is performed using an adhesive. The color filter ink is continuously provided into each droplet discharge head (into each cavity) by repeatedly discharging droplets of the color filter ink, and vibration energy, for example, caused by the discharge of droplets is applied to the junctions at which the adhesive is used. A droplet discharge apparatus for industrial use used to produce color filters is quite different from that applied to a printer for consumer use, and is required to discharge a great amount of droplets over an extended period of time for mass production. In general, an ink used in an industrial droplet discharge apparatus is higher in viscosity and specific gravity than that used in a consumer droplet discharge apparatus. Therefore, the load on the droplet discharge heads of the former is much larger than that on those of the latter. Since the industrial droplet discharge apparatus is used under such harsh conditions, use of related art color filter inks causes swelling of the adhesive or makes the junction using the adhesive inadequate. These may cause problems such as variations in discharge droplet amounts. Also, apparatuses involved in manufacture, including the droplet discharge apparatus, undergo, for example, cleaning including an aspiration step at given time intervals. In this case, the droplet discharge apparatus cannot withstand pressure variations caused by aspiration if the adhesion strength of the diaphragm is low. This causes structural defects such as distortion and deformation. As a result, structural differences between some nozzles and others occur, thereby making the discharge of droplets unstable. This causes differences among the nozzles. Such a problem causes unevenness in color density among the multiple colored parts that should have identical color densities. This results in color unevenness, density unevenness, or the like among the parts of each color filter or unevenness in characteristics (in particular, color characteristics such as contrast ratio and color reproduction area) among many color filters. Thus, the reliability of the color filters is reduced. On the other hand, the color filter ink meeting the above-described conditions is used in this embodiment. Therefore, these problems are prevented even if droplets are discharged over an extended period of time.

The diaphragm 126 is preferably bonded to the droplet discharge head 114 using, but not limited to, a urethane adhesive suitable for bonding a resin film and a metal plate together. This effectively prevents deterioration, clogging, etc. of the droplet discharge heads for discharging the color filter ink. As a result, high quality color filters with excellent characteristic uniformity among individual color filters are manufactured.

Among such urethane adhesives are SU (manufactured by Konishi Co., Ltd.), Hysol U-09FL (Henkel), and Takelac W (Mitsui Chemicals Polyurethanes, Inc.).

The controller 112 (see FIG. 3) may be configured to provide independent signals to the multiple vibrators 124. In other words, the volume of the color filter ink 2 to be discharged from each nozzle 118 may be controlled for each nozzle 118 according to a signal from the controller 112. Also, the controller 112 may set nozzles 118 that perform a discharge operation during an application scan and nozzles 118 that perform no discharge operation during the application scan.

A portion of each droplet discharge head 114 including one nozzle 118, a cavity 120 corresponding to the nozzle 118, and a vibrator 124 corresponding to the cavity 120 may be expressed as a “discharge part 127.” According to this expression, each droplet discharge head 114 includes discharge parts 127 by the number identical to that of the nozzles 118.

Multiple color filter inks 2 corresponding to the colored parts 12 having multiple colors are provided into the cells 14 using the above-described droplet discharge apparatus 100. Use of such an apparatus allows the color filter inks 2 to be effectively and selectively provided into the cells 14. While the droplet discharge apparatus 100 only includes the tank 101 for containing the color filter ink 2, the tube 110, and the like corresponding to a single color in the illustrated configuration, it may include these components so as to correspond to the colored parts 12 having multiple colors included in the color filter 1. Also, multiple droplet discharge apparatuses 100 corresponding to multiple color filter inks 2 having multiple colors may be used to manufacture the color filter 1.

In this embodiment, each droplet discharge head 114 may use an electrostatic actuator, instead of the piezoelectric element, as a drive element. Also, each droplet discharge head 114 may use an electric thermal conversion element as a drive element and discharge the color filter ink using the thermal expansion of a material caused by this electric thermal conversion element.

Colored Part Forming Step

Next, the solid colored parts 12 are formed by eliminating the liquid medium from the color filter ink 2 in the cells 14 (1e). Thus, the color filter 1 is obtained. Also, in this step, the resin material may be caused to react with the crosslinking component and the like, as necessary. The elimination of the liquid medium is performed, for example, by heating. In this case, the substrate 11 onto which the color filter ink 2 has been provided may be placed in a reduced-pressure environment. This prevents such elimination from adversely affecting the substrate 11 and the like, as well as allows the liquid medium to be more efficiently eliminated. Also, in this step, radiation may be applied to the provided color filter ink 2. This allows the resin material to efficiently react with the crosslinking component and the like.

Image Display

A liquid crystal display that is an image display (electrooptic apparatus) including the color filter 1 according to this embodiment will now be described.

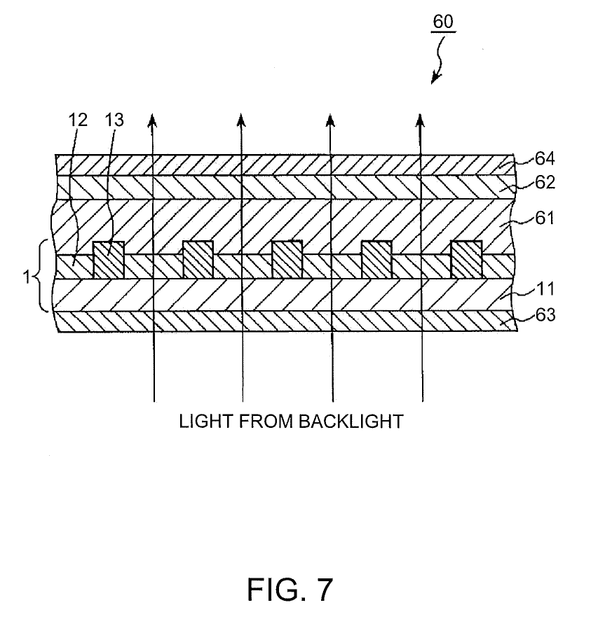

FIG. 7 is a sectional view showing a liquid crystal display according to this embodiment. As shown in FIG. 7, a liquid crystal display 60 includes the color filter 1, a substrate (counter substrate) 62 provided to face the colored parts 12 of the color filter 1, a liquid crystal layer 61 including liquid crystal sealed in the gap between the color filter 1 and the substrate 62, a polarizing plate 63 provided below the substrate 11 of the color filter 1 in FIG. 7, and a polarizing plate 64 provided on the substrate 62 in FIG. 7. The substrate 62 is a substrate transparent to visible light, such as a glass substrate.

The liquid crystal display 60 includes multiple pixel electrodes (not shown) that are disposed in a matrix and transparent to visible light, multiple switching elements (not shown), such as thin film transistors (TFTs), corresponding to the pixel electrodes, and a common electrode (not shown) that is transparent to visible light.

Light beams emitted from a backlight (not shown) enter the liquid crystal display 60 from a surface of the display 60 adjacent to the color filter 1 (from a lower part of FIG. 7). The light beams that have entered the colored parts 12 of the color filter 1 exit from the opposite surface of the display 60 as light beams having colors corresponding to the colored parts 12 (12A, 12B, 12C).

As described above, the colored parts 12 are formed using the color filter ink 2 according to this embodiment. Therefore, characteristic unevenness among the pixels is suppressed. As a result, images in which color unevenness and density unevenness among parts of each pixel are suppressed are stably displayed on the liquid crystal display 60.

Electronic Apparatus

An image display (electrooptic apparatus) 1000 such as the liquid crystal display including the color filter 1 as described above is used in the display units of various electronic apparatuses.

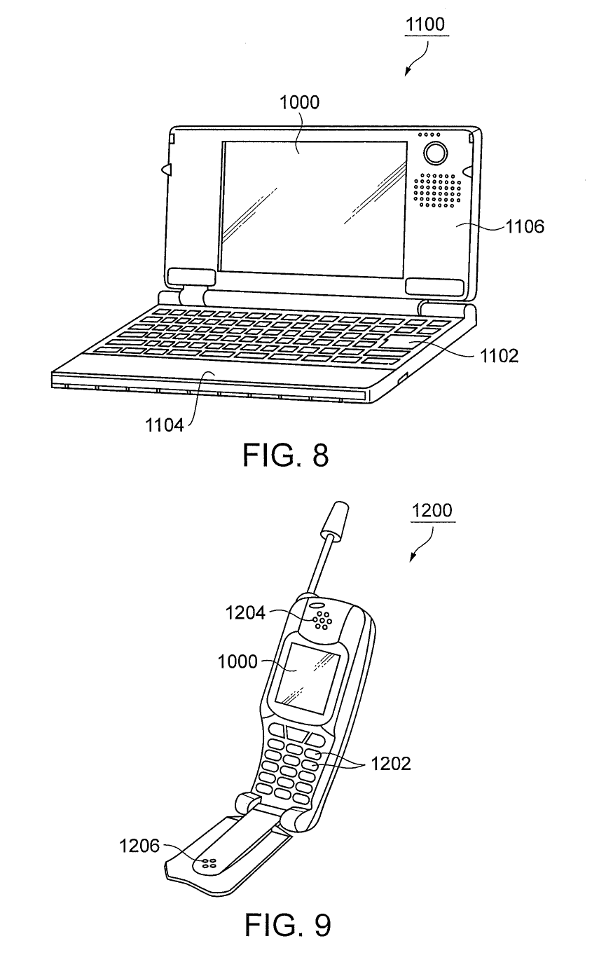

FIG. 8 is a perspective view showing a configuration of a mobile (or notebook) personal computer to which an electronic apparatus according to this embodiment is applied.

In this drawing, a personal computer 1100 includes a main body 1104 having a keyboard 1102 and a display unit 1106. The display unit 1106 is supported by the main body 1104 in a manner that the display unit 1106 is rotatable about a hinge structure.

In the personal computer 1100, the display unit 1106 includes the image display 1000.

FIG. 9 is a perspective view showing a configuration of a cellular phone (such cellular phones include personal handyphone system (PHS) phones) to which an electronic apparatus according to this embodiment is applied.

In this drawing, a cellular phone 1200 includes multiple operation buttons 1202, an ear piece 1204, and a mouth piece 1206 as well as the image display 1000 as a display unit.

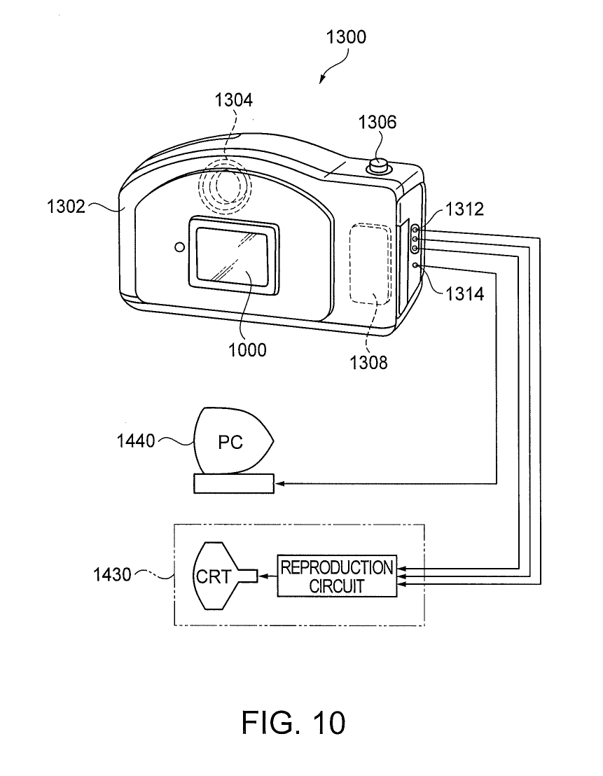

FIG. 10 is a perspective view showing a configuration of a digital still camera to which an electronic apparatus according to this embodiment is applied. This drawing also shows the connections between the digital still camera and external apparatuses in a simplified manner.

While an ordinary camera exposes a silver-salt photo film to light using the light figure of an object, the digital still camera 1300 photoelectrically converts the light figure of an object into an image signal using an image pickup device such as a charge coupled device (CCD).

The image display 1000 is provided as a display unit on the back of a case (body) 1302 of the digital still camera 1300 so as to display an image according to an image signal obtained using the CCD. The image display 1000 serves as a finder for displaying an object as an electronic image.

The case contains a circuit substrate 1308. The circuit substrate 1308 includes a memory for storing image signals.

A photoreceptor unit 1304 including an optical lens (image pickup system), a CCD, and the like is provided on the front side of the case 1302 (on the back of FIG. 10).

When a user confirms an object image displayed on the display unit and then presses down a shutter button 1306, an image generated by the CCD at that time is transferred to the memory of the circuit substrate 130 and stored therein.

Also, in the digital still camera 1300, a video signal output terminal 1312 and an input/output terminal 1314 for data communication are provided on the sides of the case 1302. As illustrated, a television monitor 1430 is coupled to the video signal output terminal 1312 and a personal computer 1440 is coupled to the input/output terminal 1314 for data communication, as necessary. In this case, an image signal stored in the memory of the circuit substrate 1308 is outputted to the television monitor 1430 or the personal computer 1440 according to a predetermined operation.

In addition to the above-described personal computer (mobile personal computer), cellular phone, and digital still camera, an electronic apparatus according to this embodiment is applicable to, for example, televisions (e.g., liquid crystal televisions), video cameras, view finder-type or monitor direct view-type video tape recorders, laptop personal computers, car navigation systems, pagers, electronic notepads (including those having a communication function), electronic dictionaries, electronic calculators, electronic games, word processors, workstations, picturephones, security television monitors, electronic binoculars, point-of-sale (POS) terminals, apparatuses including a touch panel (e.g., cash dispensers in banking facilities, automatic ticket machines), medical equipment (e.g., electronic thermometers, sphygmomanometers, blood glucose meters, electrocardiogram displays, ultrasonic diagnostic equipment, endoscope displays), fish finders, various types of measuring equipment, measuring instruments (e.g., measuring instruments for use in automobiles, airplanes, and ships), flight simulators, other various types of monitors, projection-type displays such as projectors, and the like. Incidentally, the trend toward upsizing of the display units of televisions is remarkable in recent years. However, if color filters manufactured using related art color filter inks are applied to electronic apparatuses having such a large-size display unit (e.g., display unit having a diagonal line of 80 cm or more), problems such as color unevenness and density unevenness are apt to occur. Therefore, application of the color filter ink according to this embodiment reliably prevents such problems. That is, if the color filter ink according to this embodiment is applied to an electronic apparatus having a large-size display unit as described above, the advantage of the invention is exhibited more remarkably.

While the invention has been described based on the preferred embodiment, the invention is not limited thereto.

For example, in the above-described embodiment, the multiple color filter inks corresponding to the colored parts having multiple colors are provided into the cells and then the liquid medium is eliminated all at once from the color filter inks having multiple colors in the cells. That is, the colored part forming step is performed only once. However, the ink providing step and the colored part forming step may be repeated to correspond to each of the multiple colors.

Also, in the color filter according to this embodiment, a protection film for covering the colored parts may be provided on surfaces of the colored parts opposite to surfaces thereof facing the substrate. This effectively prevents damages to the colored parts, deterioration thereof, or the like.

Any components included in the color filter, the image display, and the electronic apparatus according to this embodiment may be replaced with arbitrary components having a similar function, or other components may be added thereto.

### WORKING EXAMPLE

### 1. Preparation of Color Filter Ink

### Working Example 1

First, a resin “a” as a resin material was synthesized in the following manner.

320 w/t parts of n-hexane, 86 w/t parts of methacrylic acid, 111 w/t parts of triethylamine were put into a four-necked flask and then a thermometer, a reflux condenser, an agitator, and a nitrogen gas inlet were attached to the four-necked flask. Then, 120 w/t parts of trimethylchlorosilane is dropped into the four-necked flask while cooling the flask using ice water. At this time, the temperature in a reaction system was set to 25° C. or less. Then, a reaction was continued at a temperature of 25° C. for one hour. Subsequently, hydrochloride of the triethylamine was filtered off and n-hexane was eliminated from the obtained filtrate under reduced pressure, and then the resultant filtrate was purified by distilling the filtrate under reduced pressure. Thus, an ethylene unsaturated monomer having a silyl acetate structure was obtained.

Next, a four-necked flask to which a thermometer, a reflux condenser, an agitator, and a nitrogen gas inlet are attached and into which 100 w/t parts of bis(2-butoxyethyl)ether is put as a solvent was prepared. Then, the temperature of the bis(2-butoxyethyl)ether in this four-necked flask was raised up to 60° C. while agitating the bis(2-butoxyethyl)ether, and then a mixture of 27 w/t parts of the ethylene unsaturated monomer, 30 w/t parts of glycidyl methacrylate, 38 w/t parts of styrene, and 6 w/t parts of 2,2′-azobis-(2,4-dimethylvaleronitrile) was dropped into the flask for one hour. The mixture was maintained at a temperature of 60° C. for one hour after the dropping, and then 0.08 w/t parts of 2,2′-azobis-(2,4-dimethylvaleronitrile) was added to the mixture, and then the resultant mixture was caused to react at a temperature of 60° C. for six hours. Subsequently, an unreacted monomer was eliminated from the mixture by decompressing the mixture. Thus, a solution of the resin “a” as an epoxy resin having a silyl acetate structure and an epoxy structure was obtained.

On the other hand, bis(2-butoxyethyl)ether (liquid medium) was prepared, and Disperbyk-161 (manufactured by BYK Japan KK; a compound having a cyamelide) as a dispersant, and C.I. pigment red 254 and C.I. pigment yellow 150 as colorants were added to the bis(2-butoxyethyl)ether. Subsequently, the resultant bis(2-butoxyethyl)ether was introduced into a bead mill (using a zirconia bead with a diameter of 0.65 mm) to crush pigments. Thus, a pigment dispersion liquid was obtained.

Subsequently, a red color filter ink (R ink) was prepared by mixing the solution of the resin “a” and the pigment dispersion liquid. The average particle diameter of the C.I. pigment red 254 and that of the C.I. pigment yellow 150 in the R ink were both 160 nm.

A green color filter ink (G ink) and a blue color filter ink (B ink) were prepared in a manner similar to that in which the red color filter ink was prepared, except that the types of the colorants and the amount of usage of each ingredient were changed. Thus, an ink set including the inks having three colors, RGB, was obtained. The average particle diameter of the C.I. pigment green 36 and that of the C.I. pigment yellow 150 in the G ink and that of the C.I. pigment blue 15:6 in the B ink were all 160 nm.

### Working Examples 2 to 13

Color filter inks (ink sets) according to Working Examples 2 to 13 were prepared in a manner similar to that in which the color filter inks (ink set) according to Working Examples 1 was prepared. The types of the liquid media and the amount of usage of each ingredient are shown in Tables 1 and 2 below. Note that if the composition of the liquid medium is changed, the resin “a” is synthesized using a solvent whose composition is changed in conjunction with the change. A solution of the resin “a” synthesized in this way was used to prepare each color filter ink.

### Comparative Examples 1 to 8

Color filter inks (ink sets) according to Comparative Examples 1 to 8 were prepared in a manner similar to that in which the color filter inks (ink set) according to Working Examples 1 was prepared. The types of the liquid media and the amount of usage of each ingredient are shown in Table 3 below. Note that if the composition of the liquid medium is changed, the resin “a” is synthesized using a solvent whose composition is changed in conjunction with the change. A solution of the resin “a” synthesized in this way was used to prepare each color filter ink.

The compositions and viscosities of the color filter inks according to the Working Examples and Comparative Examples are organized into Tables 1 to 3 together with the characteristics of the liquid medium. In the tables, C.I. pigment red 254 is denoted by “PR254,” C.I. pigment green 36 by “PG36,” C.I. pigment blue 15:6 by “PB15:6,” C.I. pigment yellow 150 by “PY150,” the above-described resin “a” by “a,” Disperbyk-161 (dispersant) by “b,” bis(2-butoxyethyl)ether by “A,” 2-(2-methoxy-1-methylethoxy)-1-methylacetate by “B,” ethoxy propionic acid ethyl by “C,” diethyleneglycol monobutylether acetate by “D,” 1,3-butylene glycol diacetate by “E,” ethylene glycol diacetate by “F,” 4-methyl-1,3-dioxolane-2-one by “G,” diethyleneglycol butyl methyl ether by “H,” glutaric acid dimethyl by “I,” tetraethylene glycol dimethylether by “J,” and triethylene glycol dimethylether by “K.” In the tables, the viscosities of the color filter inks at a temperature of 25 measured in conformity with JIS Z8809 using a vibration-type viscometer are shown in the “Viscosity” field, the boiling points of the liquid medium at a normal atmospheric pressure (1 atmospheric pressure) are shown in the “Boiling point” field, the vapor pressures of the liquid medium at a temperature of 25° C. are shown in the “Vapor pressure” field, and the swelling rates of a hardened material (a discord test piece with a diameter of 6 mm and a thickness of 4 mm) of an urethane adhesive (Hysol U-09FL (Henkel)) in a case where the urethane adhesive is left intact at atmospheric pressure and a temperature of 70° C. for six days in a sealed liquid medium are shown in the “Swelling rate of Hardened Material of Urethane Adhesive” field.

TABLE 1

| | | | | | | | | | | | | | Liquid medium characteristics | | |
|---|---|---|---|---|---|---|---|---|---|---|---|---|---|---|---|
| | | Color filter ink | | | | | | | | | | | | | Swelling |
| | | Composition | | | | | | | | | | | | | rate of |
| | | | | | | Resin | | | | Liquid | | | | | hardened |
| | | Colorant | | | | material | | Dispersant | | medium | | | | | material of |
| | | | Content | | Content | | Content | | Content | | Content | | Boiling | Vapor | urethane |
| | | | [w/t | | [w/t | | [w/t | | [w/t | | [w/t | Viscosity | point | pressure | adhesive |
| | | | parts] | | parts] | | parts] | | parts] | | parts] | [mP · s] | [° C.] | [mmHg] | [%] |
| Working | R ink | PR254 | 5.3 | PY150 | 2.0 | a | 1.9 | b | 4.8 | A | 86.0 | 7.2 | 256.0 | 0.01 | 13.88 |
| example 1 | G ink | PG36 | 7.2 | PY150 | 2.9 | a | 2.0 | b | 4.8 | A | 83.1 | 7.0 | 256.0 | 0.01 | 13.88 |
| | B ink | PB15:6 | 4.9 | — | — | a | 1.9 | b | 4.5 | A | 88.7 | 6.8 | 256.0 | 0.01 | 13.88 |
| Working | R ink | PR254 | 5.2 | PY150 | 1.9 | a | 2.0 | b | 4.9 | A/B | 43.0/43.0 | 5.1 | 234.5 | 0.01 | 37.72 |
| example 2 | G ink | PG36 | 7.0 | PY150 | 2.8 | a | 2.2 | b | 4.8 | A/B | 41.6/41.6 | 5.0 | 234.5 | 0.01 | 37.72 |
| | B ink | PB15:6 | 4.9 | — | — | a | 1.8 | b | 4.5 | A/B | 44.5/44.5 | 5.0 | 234.5 | 0.01 | 37.72 |
| Working | R ink | PR254 | 5.1 | PY150 | 1.9 | a | 2.0 | b | 4.8 | A/D | 69.0/17.2 | 6.3 | 254.2 | 0.02 | 24.59 |
| example 3 | G ink | PG36 | 7.0 | PY150 | 2.8 | a | 2.1 | b | 4.7 | A/D | 66.7/16.7 | 6.5 | 254.2 | 0.02 | 24.59 |
| | B ink | PB15:6 | 4.8 | — | — | a | 1.7 | b | 4.5 | A/D | 71.2/17.8 | 6.2 | 254.2 | 0.02 | 24.59 |
| Working | R ink | PR254 | 5.2 | PY150 | 2.1 | a | 2.2 | b | 4.5 | A/E | 68.8/17.2 | 6.4 | 251.2 | 0.02 | 33.73 |
| example 4 | G ink | PG36 | 7.2 | PY150 | 2.9 | a | 2.1 | b | 5.0 | A/E | 66.2/16.6 | 6.5 | 251.2 | 0.02 | 33.73 |
| | B ink | PB15:6 | 4.9 | — | — | a | 1.9 | b | 4.8 | A/E | 70.7/17.7 | 6.3 | 251.2 | 0.02 | 33.73 |
| Working | R ink | PR254 | 5.0 | PY150 | 1.9 | a | 2.2 | b | 4.8 | A/H | 60.3/25.8 | 6.6 | 242.8 | 0.01 | 42.84 |
| example 5 | G ink | PG36 | 7.3 | PY150 | 3.1 | a | 2.1 | b | 4.9 | A/H | 57.8/24.8 | 6.7 | 242.8 | 0.01 | 42.84 |
| | B ink | PB15:6 | 4.8 | — | — | a | 1.9 | b | 5.1 | A/H | 61.7/26.5 | 6.5 | 242.8 | 0.01 | 42.84 |
| Working | R ink | PR254 | 5.1 | PY150 | 1.9 | a | 2.9 | b | 5.4 | B | 84.7 | 6.1 | 213.0 | 0.02 | 61.35 |
| example 6 | G ink | PG36 | 7.3 | PY150 | 2.0 | a | 2.8 | b | 5.0 | B | 82.9 | 5.9 | 213.0 | 0.02 | 61.35 |
| | B ink | PB15:6 | 4.9 | — | — | a | 1.8 | b | 4.9 | B | 88.4 | 5.6 | 213.0 | 0.02 | 61.35 |
| Working | R ink | PR254 | 5.2 | PY150 | 2.2 | a | 2.2 | b | 4.8 | B/D | 59.9/25.7 | 7.3 | 223.1 | 0.03 | 76.89 |
| example 7 | G ink | PG36 | 7.2 | PY150 | 2.0 | a | 1.9 | b | 5.1 | B/D | 58.7/25.1 | 7.1 | 223.1 | 0.03 | 76.89 |
| | B ink | PB15:6 | 4.9 | — | — | a | 2.3 | b | 5.8 | B/D | 60.9/26.1 | 6.7 | 223.1 | 0.03 | 76.89 |
| Working | R ink | PR254 | 5.3 | PY150 | 2.0 | a | 2.5 | b | 5.0 | B/E | 59.6/25.6 | 6.9 | 218.7 | 0.03 | 76.89 |
| example 8 | G ink | PG36 | 7.2 | PY150 | 3.1 | a | 1.8 | b | 5.1 | B/E | 53.8/29.0 | 6.9 | 219.7 | 0.03 | 79.45 |
| | B ink | PB15:6 | 4.7 | — | — | a | 1.9 | b | 5.0 | B/E | 44.2/44.2 | 6.9 | 222.5 | 0.03 | 87.16 |

TABLE 2

| | | | | | | | | | | | | | Liquid medium characteristics | | |
|---|---|---|---|---|---|---|---|---|---|---|---|---|---|---|---|
| | | Color filter ink | | | | | | | | | | | | | Swelling |
| | | Composition | | | | | | | | | | | | | rate of |
| | | | | | | Resin | | | | Liquid | | | | | hardened |
| | | Colorant | | | | material | | Dispersant | | medium | | | | | material of |
| | | | Content | | Content | | Content | | Content | | Content | | Boiling | Vapor | urethane |
| | | | [w/t | | [w/t | | [w/t | | [w/t | | [w/t | Viscosity | point | pressure | adhesive |
| | | | parts] | | parts] | | parts] | | parts] | | parts] | [mP · s] | [° C.] | [mmHg] | [%] |
| Working | R ink | PR254 | 5.2 | PY150 | 2.0 | a | 2.1 | b | 4.8 | D | 85.9 | 8.1 | 248.6 | 0.04 | 67.1 |
| example 9 | G ink | PG36 | 7.1 | PY150 | 2.9 | a | 2.2 | b | 4.8 | D | 83.0 | 8.2 | 248.6 | 0.04 | 67.1 |
| | B ink | PB15:6 | 4.8 | — | — | a | 1.9 | b | 4.5 | D | 88.8 | 7.7 | 248.6 | 0.04 | 67.1 |
| Working | R ink | PR254 | 5.1 | PY150 | 1.9 | a | 2.2 | b | 4.8 | D/E | 43.0/43.0 | 7.9 | 239.4 | 0.04 | 89.86 |
| example | G ink | PG36 | 7.0 | PY150 | 2.9 | a | 2.5 | b | 5.2 | D/E | 41.2/41.2 | 7.9 | 239.4 | 0.04 | 89.86 |
| 10 | B ink | PB15:6 | 4.9 | — | — | a | 2.1 | b | 4.8 | D/E | 44.1/44.1 | 7.7 | 239.4 | 0.04 | 89.86 |
| Working | R ink | PR254 | 5.1 | PY150 | 1.9 | a | 2.2 | b | 5.1 | E | 86.0 | 7.9 | 232.0 | 0.04 | 111.76 |
| example | G ink | PG36 | 7.0 | PY150 | 2.8 | a | 2.5 | b | 5.2 | E | 82.9 | 8.0 | 232.0 | 0.04 | 111.76 |
| 11 | B ink | PB15:6 | 4.7 | — | — | a | 2.1 | b | 4.8 | E | 88.7 | 7.6 | 232.0 | 0.04 | 111.76 |
| Working | R ink | PR254 | 5.2 | PY150 | 2.1 | a | 2.2 | b | 4.8 | F | 85.7 | 9.8 | 187.0 | 0.04 | 134.55 |
| example | G ink | PG36 | 7.4 | PY150 | 2.9 | a | 2.5 | b | 5.2 | F | 82.0 | 9.6 | 187.0 | 0.04 | 134.55 |
| 12 | B ink | PB15:6 | 4.9 | — | — | a | 2.1 | b | 4.6 | F | 88.4 | 9.2 | 187.0 | 0.04 | 134.55 |
| Working | R ink | PR254 | 5.0 | PY150 | 1.9 | a | 2.1 | b | 4.7 | E/H | 25.9/60.4 | 7.0 | 218.0 | 0.03 | 110.99 |
| example | G ink | PG36 | 7.0 | PY150 | 2.7 | a | 2.2 | b | 5.1 | E/H | 24.9/58.1 | 7.2 | 218.0 | 0.03 | 110.99 |
| 13 | B ink | PB15:6 | 4.7 | — | — | a | 1.8 | b | 4.9 | E/H | 25.9/62.0 | 6.9 | 218.0 | 0.03 | 110.99 |

TABLE 3

| | | | | | | | | | | | | | Liquid medium characteristics | | |
|---|---|---|---|---|---|---|---|---|---|---|---|---|---|---|---|
| | | Color filter ink | | | | | | | | | | | | | Swelling |
| | | Composition | | | | | | | | | | | | | rate of |
| | | | | | | Resin | | | | Liquid | | | | | hardened |
| | | Colorant | | | | material | | Dispersant | | medium | | | | | material of |
| | | | Content | | Content | | Content | | Content | | Content | | Boiling | Vapor | urethane |
| | | | [w/t | | [w/t | | [w/t | | [w/t | | [w/t | Viscosity | point | pressure | adhesive |
| | | | parts] | | parts] | | parts] | | parts] | | parts] | [mP · s] | [° C.] | [mmHg] | [%] |
| Compara- | R ink | PR254 | 5.1 | PY150 | 1.9 | a | 2.0 | b | 4.8 | C | 86.2 | 7.9 | 171.0 | 0.6 | 163.50 |
| tive | G ink | PG36 | 7.5 | PY150 | 2.8 | a | 2.2 | b | 4.9 | C | 82.6 | 7.8 | 171.0 | 0.6 | 163.50 |
| example 1 | B ink | PB15:6 | 4.8 | — | — | a | 1.9 | b | 4.9 | C | 88.4 | 7.7 | 171.0 | 0.6 | 163.50 |
| Compara- | R ink | PR254 | 5.2 | PY150 | 2.0 | a | 2.2 | b | 4.6 | G | 86.0 | 7.4 | 243.0 | 0.03 | 157.85 |
| tive | G ink | PG36 | 7.5 | PY150 | 2.9 | a | 2.1 | b | 5.0 | G | 82.5 | 7.5 | 243.0 | 0.03 | 157.85 |
| example 2 | B ink | PB15:6 | 4.8 | — | — | a | 1.8 | b | 4.5 | G | 88.9 | 7.2 | 243.0 | 0.03 | 157.85 |
| Compara- | R ink | PR254 | 5.3 | PY150 | 2.0 | a | 2.1 | b | 4.8 | C/G | 17.2/68.6 | 7.5 | 228.4 | 0.32 | 158.98 |
| tive | G ink | PG36 | 7.5 | PY150 | 2.9 | a | 2.2 | b | 5.2 | C/G | 16.4/65.8 | 7.4 | 228.4 | 0.32 | 158.98 |
| example 3 | B ink | PB15:6 | 4.8 | — | — | a | 1.8 | b | 4.5 | C/G | 17.8/71.1 | 7.2 | 228.4 | 0.32 | 158.98 |
| Compara- | R ink | PR254 | 5.1 | PY150 | 2.0 | a | 2.0 | b | 4.7 | C/I | 17.2/68.8 | 7.5 | 206.0 | 0.37 | 210.74 |
| tive | G ink | PG36 | 7.2 | PY150 | 2.8 | a | 2.1 | b | 4.9 | C/I | 16.5/66.2 | 7.6 | 206.0 | 0.37 | 210.74 |
| example 4 | B ink | PB15:6 | 4.8 | — | — | a | 1.8 | b | 4.6 | C/I | 17.8/71.1 | 7.3 | 206.0 | 0.37 | 210.74 |
| Compara- | R ink | PR254 | 5.0 | PY150 | 2.1 | a | 2.1 | b | 4.8 | G/K | 43.0/43.0 | 7.3 | 229.5 | 0.04 | 655.29 |
| tive | G ink | PG36 | 7.3 | PY150 | 2.8 | a | 2.2 | b | 4.9 | G/K | 41.4/41.4 | 7.4 | 229.5 | 0.04 | 655.29 |
| example 5 | B ink | PB15:6 | 4.8 | — | — | a | 1.9 | b | 5.3 | G/K | 44.0/44.0 | 7.1 | 229.5 | 0.04 | 655.29 |
| Compara- | R ink | PR254 | 5.3 | PY150 | 1.9 | a | 2.9 | b | 5.4 | I | 84.5 | 7.8 | 215.0 | 0.097 | 218.51 |
| tive | G ink | PG36 | 7.2 | PY150 | 2.0 | a | 2.8 | b | 5.0 | I | 83.0 | 8.0 | 215.0 | 0.097 | 218.51 |
| example 6 | B ink | PB15:6 | 4.4 | — | — | a | 1.8 | b | 4.9 | I | 88.9 | 7.7 | 215.0 | 0.097 | 218.51 |
| Compara- | R ink | PR254 | 5.1 | PY150 | 1.9 | a | 2.9 | b | 4.8 | I | 85.3 | 8.0 | 275.3 | 0.01 | 338.23 |
| tive | G ink | PG36 | 7.2 | PY150 | 2.0 | a | 1.9 | b | 5.1 | I | 83.8 | 8.2 | 275.3 | 0.01 | 338.23 |
| example 7 | B ink | PB15:6 | 4.5 | — | | a | 2.4 | b | 5.8 | I | 87.3 | 7.8 | 275.3 | 0.01 | 338.23 |
| Compara- | R ink | PR254 | 5.0 | PY150 | 2.0 | a | 2.7 | b | 5.0 | K | 85.3 | 8.4 | 216.0 | 0.04 | 1103.16 |
| tive | G ink | PG36 | 7.0 | PY150 | 3.1 | a | 1.5 | b | 5.1 | K | 83.3 | 8.6 | 216.0 | 0.04 | 1103.16 |
| example 8 | B ink | PB15:6 | 5.0 | — | — | a | 1.9 | b | 5.0 | K | 88.1 | 8.2 | 216.0 | 0.04 | 1103.16 |

### 2. Manufacturing Color Filter

Color filters were manufactured in the following manner using the prepared color filter inks (ink sets) according to the Working Examples and Comparative Examples.

First, a substrate (G5 size: 1100×1300 mm) that is made of a soda glass and on both surfaces of which a silica (SiO₂) film for preventing elution of sodium ions is formed was prepared and subjected to cleaning.

Next, a radiation-sensitive composition including carbon black and for forming banks is provided onto almost all of one surface of the cleaned substrate so as to form a coating.

Next, pre-baking was performed under the conditions: heating temperature of 110° C. and heating time of 120 sec.

Subsequently, post exposure baking (PEB) was performed by applying a radiation to the coating using a photomask, and then development was performed using an alkali developer and post baking was performed. Thus, banks were formed. The PEB was performed under the conditions: heating temperature of 110° C., heating time of 120 sec. and radiation application intensity of 150 mJ/cm². The development was performed using a vibration/development method. The development time was set to 60 sec. The post baking was performed under the conditions: heating temperature of 150° C. and heating time of 5 min. The thickness of the formed banks was 2.1 μm.

Next, each color filter ink was discharged into the cells that are regions surrounded by the banks, using a droplet discharge apparatus as described in FIGS. 3 to 6. In this case, the color filter inks having three colors were used with respect to each of the Working Examples and Comparative Examples in a manner that the color filter inks having three colors cause no color mixture. As a droplet discharge head, one to which a diagram is bonded using a urethane adhesive (Hysol U-09FL manufactured by Henkel) was used.

Subsequently, the colored parts having three colors were formed by heating the substrate on a hot plate at a temperature of 100° C. for 10 min. and then heating the substrate at a temperature of 200° C. in an oven for one hour. Thus, a color filter as described in FIG. 1 was obtained.

One thousand color filters were manufactured for each of the Working Examples and Comparative Examples using the color filter inks (ink sets) according thereto in the above-described manner.

### 3. Evaluation

The following evaluations were performed using the color filters obtained in the above-described manner.

3.1 Color Unevenness, Density Unevenness, and Light Leakage

Liquid crystal displays as described in FIG. 7 are manufactured under the same conditions using the respective one thousandth color filters among the color filters manufactured using the color filter inks (ink sets) according to the Working Examples and Comparative Examples.

Using these liquid crystal displays, red, green, blue, and white is independently displayed in a darkroom, and each display was visually observed. Then, the state of occurrence of color unevenness and density unevenness among parts of each liquid crystal display was evaluated according to the following five stages of criteria.

A: No color unevenness, density unevenness, and light leakage are recognized.

B: Almost no color unevenness, density unevenness, and light leakage are recognized.

C: Color unevenness, density unevenness, and/or light leakage are slightly recognized.

D: Color unevenness, density unevenness, and/or light leakage are obviously recognized.

E: Color unevenness, density unevenness, and/or light leakage are remarkably recognized.

3.2 Differences in Characteristics between Color Filters

The respective 990th to 999th color filters among the color filters manufactured using the color filter inks (ink sets) according to the Working Examples and Comparative Examples were prepared. Then, red, green, blue, and white were independently displayed on these color filters in a darkroom, and the colors were measured using a spectrophotometer (MCPD3000 manufactured by Otsuka Electronics Co., Ltd.). From the results, the largest color difference (color difference ΔE in a Lab display system) among the 990th to 999th color filters was obtained with respect to each of the Working Examples and Comparative Examples. Then, the obtained color differences were evaluated according to the following five stages of criteria.

A: Color difference (ΔE) is less than 2

B: Color difference (ΔE) is 2 or more and less than 3

C: Color difference (ΔE) is 3 or more and less than 4

D: Color difference (ΔE) is 4 or more and less than 5

E: Color difference (ΔE) is 5 or more

Each color filter was observed and measured under the same conditions when performing the above-described evaluations. The evaluation results are shown in Table 4.

TABLE 4

| | Color unevenness, | | | | Differences in | | | |
|---|---|---|---|---|---|---|---|---|
| | density unevenness, | | | | characteristics among | | | |
| | light leakage | | | | individual color filters | | | |
| | During | During | During | During | During | During | During | During |
| | red | green | blue | white | red | green | blue | white |
| | display | display | display | display | display | display | display | display |
| Working | A | A | A | A | A | A | A | A |
| example 1 | | | | | | | | |
| Working | A | A | A | A | A | A | A | A |
| example 2 | | | | | | | | |
| Working | A | A | A | A | A | A | A | A |
| example 3 | | | | | | | | |
| Working | A | A | A | A | A | A | A | A |
| example 4 | | | | | | | | |
| Working | A | A | A | A | A | A | A | A |
| example 5 | | | | | | | | |
| Working | A | A | A | A | A | A | A | A |
| example 6 | | | | | | | | |
| Working | A | A | A | A | A | A | A | A |
| example 7 | | | | | | | | |
| Working | A | A | A | A | A | B | A | A |
| example 8 | | | | | | | | |
| Working | A | A | A | B | A | B | A | B |
| example 9 | | | | | | | | |
| Working | A | B | A | A | A | B | A | A |
| example 10 | | | | | | | | |
| Working | A | B | A | A | A | B | A | A |
| example 11 | | | | | | | | |
| Working | B | B | A | B | B | B | A | B |
| example 12 | | | | | | | | |
| Working | A | B | A | A | A | B | A | A |
| example 13 | | | | | | | | |
| Comparative | B | C | B | D | B | C | B | D |
| example 1 | | | | | | | | |
| Comparative | B | C | A | C | B | C | A | C |
| example 2 | | | | | | | | |
| Comparative | B | C | B | C | B | C | B | C |
| example 3 | | | | | | | | |
| Comparative | C | C | B | C | C | C | B | C |
| example 4 | | | | | | | | |
| Comparative | C | E | D | C | C | E | D | D |
| example 5 | | | | | | | | |
| Comparative | C | D | C | C | C | D | D | C |
| example 6 | | | | | | | | |
| Comparative | D | E | C | D | D | E | D | D |
| example 7 | | | | | | | | |
| Comparative | D | E | C | E | D | E | D | E |
| example 8 | | | | | | | | |

As is evident from FIG. 4, color mixture, color unevenness, density unevenness, and light leakage was suppressed and unevenness in characteristics among individual color filters was small in the Working Examples, while satisfactory results were not obtained from the Comparative Examples.

Also, a commercially available liquid crystal television was dissembled, its liquid crystal display part was replaced with a liquid crystal display manufactured in the above-described manner, and then the same evaluations as those described above were performed. As a result, similar results were obtained.

What is claimed is:

1. A color filter ink used to manufacture a color filter by an inkjet method, the ink comprising:
a colorant; and
a liquid medium for at least one of dissolving and dispersing the colorant,
wherein the liquid medium has an adhesive swelling characteristic including:
causing a hardened urethane adhesive material to have a swelling rate of 140% or less after the hardened urethane adhesive material is left intact and sealed in the liquid medium at atmospheric pressure and at a temperature of 40° C. for ten days, and
the liquid medium has, at an end of a molecule chain, at least one of:
an alkoxyl group with a carbon number of four or more, and
an acetyl group.

2. The color filter ink according to claim 1, wherein
the liquid medium has an acetyl group at both ends of the molecule chain.

3. The color filter ink according to claim 1, wherein
the liquid medium has an alkoxyl group at both ends of the molecule chain, a carbon number of the alkoxyl group being four or more.

4. The color filter ink according to claim 1, wherein
the liquid medium has an ether oxygen atom linked to a second carbon atom, in a molecule.

5. The color filter ink according to claim 1, wherein
a boiling point of the liquid medium at atmospheric pressure is in a range of 180 to 300° C.

6. The color filter ink according to claim 1, wherein
a vapor pressure of the liquid medium at a temperature of 25° C. is 0.1 mmHg or less.

7. A color filter, wherein
the color filter is manufactured using the color filter ink according to claim 1.

8. An image display comprising:
the color filter according to claim 7.

9. The image display according to claim 8, wherein
the image display is a liquid crystal panel.

10. An electronic apparatus comprising:
the image display according to claim 8.

11. A liquid droplet discharging apparatus comprising:
a tank;
a color filter ink stored in the tank;
at least one liquid droplet discharging head in ink receiving communication with the tank and adapted to discharge the color filter ink to a desired location, the liquid droplet discharging head including:
a nozzle plate; and
a diaphragm bonded with a hardened urethane adhesive;
wherein the color filter ink includes:
a colorant; and
a liquid medium for at least one of dissolving and dispersing the colorant, the liquid medium causing the hardened urethane adhesive material to have a swelling rate of 140% or less after the hardened urethane adhesive material is left intact and sealed in the liquid medium at atmospheric pressure and at a temperature of 40° C. for ten days, and
the liquid medium has, at an end of a molecule chain, at least one of:
an alkoxyl group with a carbon number of four or more, and
an acetyl group.

12. The apparatus according to claim 11, wherein
the liquid medium has an acetyl group at both ends of the molecule chain.

13. The apparatus according to claim 11, wherein
the liquid medium has an alkoxyl group at both ends of the molecule chain, a carbon number of the alkoxyl group being four or more.

14. The apparatus according to claim 11, wherein
the liquid medium has an ether oxygen atom linked to a second carbon atom, in a molecule.

15. The apparatus according to claim 11, wherein
a boiling point of the liquid medium at atmospheric pressure is in a range of 180 to 300° C.

16. The apparatus according to claim 11, wherein
a vapor pressure of the liquid medium at a temperature of 25° C. is 0.1 mmHg or less.
